(19) United States
(12) Patent Application Publication
(10) Pub. No.: US 2022/0094174 A1
(43) Pub. Date: Mar. 24, 2022

(54) MULTI-SOURCE MICROGRID POWER SUPPLY SYSTEM IN OIL WELL AREA

(71) Applicant: CHINA UNIVERSITY OF PETROLEUM BLUE SKY(QINGDAO) PETROLEUM TECHNOLOGY CO.,LTD, Qingdao (CN)

(72) Inventors: Weizhong WEI, Qingdao (CN); Yulin LIU, Qingdao (CN); Jiasheng ZHANG, Qingdao (CN); Hongbo LI, Qingdao (CN); Zhenhua SUN, Qingdao (CN); Enfang XU, Qingdao (CN); Zhongxian GAO, Qingdao (CN); Xiaobo LIU, Qingdao (CN); Jin HE, Qingdao (CN)

(73) Assignee: CHINA UNIVERSITY OF PETROLEUM BLUE SKY(QINGDAO) PETROLEUM TECHNOLOGY CO.,LTD, Qingdao (CN)

(21) Appl. No.: 17/026,349

(22) Filed: Sep. 21, 2020

(51) Int. Cl. H02J 3/46; H02J 3/32; H02J 3/38

(52) U.S. Cl. CPC H02J 3/466; H02J 3/381; H02J 3/32

(57) ABSTRACT

Disclosed herein are multi-source microgrid power supply systems including a rectifier having an incoming line terminal connected to a low-voltage side of a transformer and an outgoing line terminal connected to a DC bus having one terminal connected to the outgoing line terminal of the rectifier, an inverter having an incoming line terminal connected to the DC bus and an outgoing line terminal connected to oil well equipment, a first voltage regulator having an incoming line terminal connected to a photovoltaic array and an outgoing line terminal connected to the DC bus, a second voltage regulator having an incoming line terminal connected to an energy storage unit and an outgoing line terminal connected to the DC bus, and a third voltage regulator having an incoming line terminal connected to a wind power generation unit and an outgoing line terminal connected to the DC bus.

### TECHNICAL FIELD

The present invention relates to the field of power supply of oilfields, in particular to a multi-source microgrid power supply system in an oil well area.

### BACKGROUND

At present, a 10 (6) KV power supply network conventionally supplies power to single wells after its voltage is decreased by transformers which are generally in one-to-one correspondence with the single wells. In this case, distribution lines are disposed in a tree shape; as a result, long branch lines and excessive distribution transformers and junctions for drop-out fuses on the lines cause much maintenance and inconvenient management. Due to the huge starting impact of AC asynchronous motors, starting currents are 5-7 times of rated currents. In this case, the transformers are required to have a large margin capacity, resulting in low power factors and serious reactive power losses during operation. A lot of idle lands around the oil wells are not effectively used. Existing new energy devices (photovoltaic power generation, power generation performed by wind power generation units, energy storage devices) for the oil wells are connected to the power supply network in a DC-DC manner to supply electric energy to the oil wells for use. Such electric energy needs shall have “inversion-rectification-inversion” conversion before used by oil wells, and such conversion inevitably causes serious losses of the electric energy.

### SUMMARY

The objective of the present invention is to provide a multi-source microgrid power supply system in an oil well area, which can reduce the loss of electric energy to achieve energy conservation.

To achieve the above purpose, the present invention provides the following technical solution.

A multi-source microgrid power supply system in an oil well area includes a transformer, a rectifier, a DC bus, an inverter, a first voltage regulator, a photovoltaic array, a second voltage regulator, an energy storage unit, a third voltage regulator, and a wind power generation unit; where

the transformer having a high-voltage side connected to a power grid of a mains supply is used to decrease a voltage to 380 V from 6/10 KV; the rectifier having an incoming line terminal connected to a low-voltage side of the transformer and an outgoing line terminal connected to the DC bus is used to convert a 380 V AC into a 560 V DC output to the DC bus; the DC bus has a terminal connected to the outgoing line terminal of the rectifier and a terminal connected to the inverter, the first voltage regulator, the second voltage regulator, and the third voltage regulator; the inverter having an incoming line terminal connected to the DC bus and an outgoing line terminal connected to an oil well equipment is used to convert a DC into an AC used for the oil well equipment; the first voltage regulator having an incoming line terminal connected to the photovoltaic array and an outgoing line terminal connected to the DC bus is used to stabilize a voltage for photovoltaic power generation at DC 600 V; the second voltage regulator has an incoming line terminal connected to the energy storage unit and an outgoing line terminal connected to the DC bus; and the third voltage regulator having an incoming line terminal connected to the wind power generation unit and an outgoing line terminal connected to the DC bus is used to convert an AC transmitted from the wind power generation unit into a DC which is output to the DC bus to be used for the oil well equipment.

Optionally, the multi-source microgrid power supply system in an oil well area further includes a high-voltage switch having a terminal connected to the high-voltage side of the transformer and a terminal connected to the power grid of the mains supply.

Optionally, the rectifier includes a filter device and an energy feedback device, where the filter device having an incoming line terminal connected to the low-voltage side of the transformer and an outgoing line terminal connected to an incoming line terminal of the energy feedback device is used to filter out harmonics generated by rectification to make total harmonic distortion (THD) meet the national standard, and the energy feedback device having an outgoing line terminal connected to the DC bus is used to feed surplus electric energy back to the power grid when it is detected that a voltage of the DC bus is higher than 700 V to prevent equipment damage caused by an overvoltage.

Optionally, a 300 Wp polycrystalline solar panel is used as the photovoltaic array.

Optionally, a lithium iron phosphate battery is used as the energy storage unit.

Optionally, a photovoltaic DC-DC voltage regulator is used as the first voltage regulator.

Optionally, an energy storage DC-DC voltage regulator is used as the second voltage regulator.

Optionally, a rectifying voltage regulator is used as the third voltage regulator.

Optionally, a fan is used as the wind power generation unit.

According to specific examples, the present invention has the following technical effects: according to the multi-source microgrid power supply system in an oil well area, a transformer having a high-voltage side connected to a power grid of a mains supply is used to decrease a voltage to 380 V from 6/10 KV; a rectifier having an incoming line terminal connected to a low-voltage side of the transformer and an outgoing line terminal connected to a DC bus is used to convert a 380 V AC into a 560 V DC output to the DC bus; the DC bus has one terminal connected to the outgoing line terminal of the rectifier and another terminal connected to an inverter, a first voltage regulator, a second voltage regulator, and a third voltage regulator; the inverter having an incoming line terminal connected to the DC bus and an outgoing line terminal connected to an oil well equipment is used to convert a DC into an AC used for the oil well equipment; the first voltage regulator having an incoming line terminal connected to a photovoltaic array and an outgoing line terminal connected to the DC bus is used to stabilize a voltage for photovoltaic power generation at DC 600 V; the second voltage regulator has an incoming line terminal connected to an energy storage unit and an outgoing line terminal connected to the DC bus; and the third voltage regulator having an incoming line terminal connected to a wind power generation unit and an outgoing line terminal connected to the DC bus is used to convert an AC transmitted from the wind power generation unit into a DC which is output to the DC bus to be used for the oil well equipment. Accordingly, the loss of electric energy is reduced to achieve energy conservation and environmental protection.

### BRIEF DESCRIPTION OF DRAWINGS

In order to illustrate the examples of the present invention or the technical solutions of the prior art more clearly, the accompanying drawing to be used in the examples will be described briefly below. Notably, the following accompanying drawing merely illustrates some examples of the present invention, but other accompanying drawings can also be obtained by a person of ordinary skill in the art based on the accompanying drawing without any creative efforts.

FIG. 1 is a structural diagram of a multi-source microgrid power supply system in an oil well area of the present invention.

### DETAILED DESCRIPTION

The following clearly and completely describes the technical solutions in the examples of the present invention with reference to accompanying drawings in the examples of the present invention. Apparently, the described examples are merely a part rather than all of the examples of the present invention. All other examples obtained by a person of ordinary skill in the art based on the examples of the present invention without creative efforts shall fall within the protection scope of the present invention.

The objective of the present invention is to provide a multi-source microgrid power supply system in an oil well area, which can reduce the loss of electric energy to achieve energy conservation.

To make the foregoing objective, features, and advantages of the present invention clearer and more comprehensible, the present invention is further described in detail below with reference to the accompanying drawings and specific embodiments.

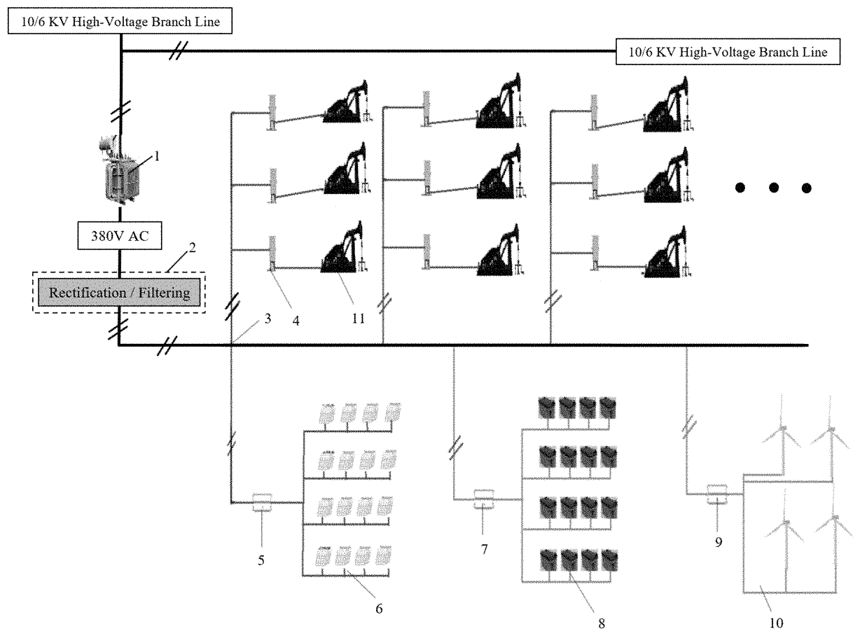

FIG. 1 shows a structural diagram of the multi-source microgrid power supply system in an oil well area of the present invention. As shown in FIG. 1, the multi-source microgrid power supply system in an oil well area includes a transformer 1, a rectifier 2, a DC bus 3, an inverter 4, a first voltage regulator 5, a photovoltaic array 6, a second voltage regulator 7, an energy storage unit 8, a third voltage regulator 9, and a wind power generation unit 10.

An S13-160 transformer 1, a ZSD-Z-160 rectifier 2, a YJLV22-1-3*50+1*25 DC bus 3, a ZSD-N-37 inverter 4, a ZSD-W-60 first voltage regulator 5, a 300 wp polycrystalline photovoltaic array 6, a ZSD-W-60 second voltage regulator 7, a ZSD-C-10 energy storage unit 8, and a ZSD-W-15 third voltage regulator 9 are adopted, and a 15 kW vertical axis wind turbine is used as the wind power generation unit 10.

The transformer 1 having a high-voltage side connected to a power grid of a mains supply through a high-voltage switch is used to decrease a voltage to 380 V from 6/10 KV; the rectifier 2 having an incoming line terminal connected to a low-voltage side of the transformer 1 and an outgoing line terminal connected to the DC bus 3 is used to convert a 380 V AC into a 560 V DC output to the DC bus 3; the DC bus 3 has one terminal connected to the outgoing line terminal of the rectifier 2 and another terminal connected to the inverter 4, the first voltage regulator 5, the second voltage regulator 7, and the third voltage regulator 9; and the inverter 4 having an incoming line terminal connected to the DC bus 3 and an outgoing line terminal connected to an oil well equipment 11 is used to convert a DC into an AC used for the oil well equipment 11 to control the operating state of the oil well equipment 11 and is used to feed electric energy from reverse power supply performed by the oil well equipment 11 back to the DC bus 3.

A photovoltaic DC-DC voltage regulator having an incoming line terminal connected to the photovoltaic array 6 and an outgoing line terminal connected to the DC bus 3 is used as the first voltage regulator 5 to stabilize a voltage for photovoltaic power generation at DC 600V, and has a maximum power tracking function, an islanding protection function, and the like. A 300 Wp polycrystalline solar panel as a photovoltaic panel is used as the photovoltaic array 6 to convert optical energy into electric energy for the oil well equipment 11.

An energy storage DC-DC voltage regulator, which has an incoming line terminal connected to an energy storage unit and an outgoing line terminal connected to the DC bus 3, is used as the second voltage regulator 7. The operating mode of the energy storage DC-DC voltage regulator is as follows:

When the voltage of the DC bus 3 is higher than 690 V, electric energy in the DC bus is stored into the energy storage unit 8 by the energy storage DC-DC voltage regulator; when the voltage of the DC bus 3 is instantly decreased to 450 V, the electric energy in the energy storage unit 8 is transmitted to the DC bus 3 by the energy storage DC-DC voltage regulator to be supplied to the oil well equipment 11 for continuous operation of the oil well equipment 11; when the voltage of the DC bus 3 is in a normal operation range of DC 450-700 V and at peak electrovalence, the electric energy in the energy storage unit 8 is transmitted to the DC bus 3 by the energy storage DC-DC voltage regulator to be used for the oil well equipment 11; and when the voltage of the DC bus 3 is in a normal operation range of DC 450-700 V and at valley electrovalence, the electric energy in the DC bus 3 is stored into the energy storage unit 8 by the energy storage DC-DC voltage regulator. A lithium iron phosphate battery as an energy storage battery is used as the energy storage unit 8.

A rectifying voltage regulator having an incoming line terminal connected to the wind power generation unit 10 and an outgoing line terminal connected to the DC bus 3 is used as the third voltage regulator 9 to convert an AC transmitted from the wind power generation unit 10 into a DC which is output to the DC bus 3 to be used for the oil well equipment 11. A fan is used as the wind power generation unit 10 to convert wind energy into electricity energy used for the oil well equipment 11.

The rectifier 2 includes a filter device and an energy feedback device, where the filter device having an incoming line terminal connected to the low-voltage side of the transformer 1 and an outgoing line terminal connected to an incoming line terminal of the energy feedback device is used to filter out harmonics generated by rectification to make THD (Total Harmonic Distortion) meet the national standard, and the energy feedback device having an outgoing line terminal connected to the DC bus 3 is used to feed surplus electric energy back to the power grid when it is detected that the voltage of the DC bus is higher than 700 V to prevent equipment damage caused by an overvoltage.

An existing multi-source microgrid power supply system in an oil well area has the following problems:

An existing control cabinet for an oil well is inconvenient to perform parameter adjustment due to a low information level and is impossible to achieve a remote parameter adjustment even if the low information level is improved; actual power is obviously considerably lower than rated power due to a low average load rate of a transformer for the oil well; a poor reactive power compensation effect and a serious loss of distribution lines are caused by a low power factor of a motor for the oil well; a poor quality of electric energy on a power grid side is caused by a frequent frequency control over the oil well; much maintenance is caused by excessive electric facilities on the distribution lines for the oil well; a serious loss of the electric energy is caused by excessive conversion links from a power generation terminal to a power receiving terminal in an existing new energy grid-connected approach; an operation stop of the oil well, which is caused by a voltage fluctuation and voltage flicker on a high-voltage side, affects production; and pollution to the power grid and certain waste of energy are caused because the phase and frequency of power from reverse power supply during operation of the oil well cannot meet the requirement for the quality of electric energy in the power grid.

According to the multi-source microgrid power supply system in an oil well area of the present invention, an intelligent inverter control cabinet acquires on-site load data, displacement data, temperature data, pressure data, and electrical parameters in real time and wirelessly transmits them to a control center for analysis and diagnosis to provide reference for a parameter adjustment during production of the oil well; and when the parameter adjustment is required for the oil well, the control center wirelessly sends a parameter adjustment command to the intelligent inverter control cabinet to achieve a remote adjustment. Accordingly, the problem that the existing control cabinet for the oil well is inconvenient to perform parameter adjustment due to the low information level and is impossible to achieve the remote parameter adjustment even if the low information level is improved is solved.

According to the multi-source microgrid power supply system in an oil well area of the present invention, a starting current of a motor is decreased by means of frequency conversion soft start to reduce the capacity of a transformer for the oil well; one transformer is simultaneously used for multiple oil wells by means of concentrated power supply, and the oil wells and the transformer are controlled by means of a control over the inverter control cabinet; and the load in the system is relatively balanced by load flow between one oil well and one oil well, in this way, the number of transformers is decreased. Accordingly, the problems that the actual power is obviously considerably lower than the rated power due to the low average load rate of the transformer for the oil well, and much maintenance is caused by the excessive electric facilities on the distribution lines for the oil well are solved.

According to the multi-source microgrid power supply system in an oil well area of the present invention, power supply from the outgoing line terminal of the rectifier to an incoming line terminal of the control cabinet for the oil well is changed to DC power supply, so that no reactive component is transmitted in a DC line, and a DC voltage is higher than an AC voltage, thus reducing the energy loss in the distribution lines; and concentrated compensation is performed by a reactive compensation device in the rectifier on the system to increase the power factor of the system to be more than 0.9. Accordingly, the problem that the poor reactive power compensation effect and the serious loss of the distribution lines are caused by the low power factor of the motor for the oil well is solved.

According to the multi-source microgrid power supply system in an oil well area of the present invention, after harmonics in the system is controlled by an APF (Active Power Filter) in the rectifier, the THD of a voltage at any load rate is lower than 3.5%, and the THD of a current at any load rate is lower than 12% and is considerably higher than that required by the GB/T 14549-1993, so that the problem that the poor quality of the electric energy on the power grid side is caused by the frequent frequency control over the oil well is solved.

According to the multi-source microgrid power supply system in an oil well area of the present invention, a DC-DC-AC conversion is performed from photovoltaic array to the DC bus and from the energy storage unit to the power receiving terminal, and an AC-DC-AC conversion is performed from wind power generation unit to the power receiving terminal, in this way, an original DC-AC-DC-AC conversion from the photovoltaic array and energy storage unit to the power receiving terminal and an original AC-DC-AC-DC-AC conversion from the wind power generation unit to the power receiving terminal are changed, so that inversion and rectification links of the photovoltaic array and the energy storage unit as well as a rectification-inversion-rectification link for the wind power generation are omitted. Accordingly, the problem that the serious loss of the electric energy is caused by the excessive conversion links from the power generation terminal to the power receiving terminal in the existing new energy grid-connected approach is solved.

According to the multi-source microgrid power supply system in an oil well area of the present invention, when the voltage fluctuation or voltage flicker occurs on the high-voltage side, the energy storage unit rapidly releases the electricity energy stored therein to stabilize the voltage across the DC bus to achieve continuous operation of a pumping unit. Accordingly, the problem that the operation stop of the oil well, which is caused by the voltage fluctuation and voltage flicker on the high-voltage side, affects production is solved.

During the reverse power supply performed by the oil well, reverse electricity energy is fed back to the DC bus by a freewheeling diode of the inverter to be used for other oil wells; when the voltage across the DC bus is increased to DC 690 V due to much reverse electricity energy, the energy storage unit starts to be charged; and when the voltage across the DC bus is increased to DC 700 V, an energy feedback unit in the rectifier starts to feed the surplus electric energy filtered by the inverter back to an AC network. Accordingly, the problem that the pollution to the power grid and certain waste of energy are caused because the phase and frequency of the power from the reverse power supply during the operation of the oil well cannot meet the requirement for the quality of the electric energy in the power grid is solved.

Each example of the present specification is described in a progressive manner, each example focuses on the difference from other examples, and the same and similar parts between the examples may refer to each other.

Several examples are used for illustration of the principles and implementation methods of the present invention. The description of the examples is used to help illustrate the apparatus and its core concept in the present invention. In addition, those of ordinary skill in the art can make various modifications in terms of specific implementation methods and scope of application in accordance with the concept of the present invention. In conclusion, the content of this specification shall not be construed as a limitation to the present invention.

1: A multi-source microgrid power supply system in an oil well area, the power supply system comprising a transformer, a rectifier, a DC bus, an inverter, a first voltage regulator, a photovoltaic array, a second voltage regulator, an energy storage unit, a third voltage regulator, and a wind power generation unit,
wherein:
the transformer has a high-voltage side connected to a power grid of a mains supply, and the transformer is configured to decrease a voltage from 6/10 KV to 380 V;
the rectifier has an incoming line terminal connected to a low-voltage side of the transformer and an outgoing line terminal connected to the DC bus that is configured to convert a 380 V AC output into a 560 V DC output to the DC bus;
the DC bus has a terminal connected to the outgoing line terminal of the rectifier and a terminal connected to the inverter, the first voltage regulator, the second voltage regulator, and the third voltage regulator;
the inverter has an incoming line terminal connected to the DC bus and an outgoing line terminal connected to oil well equipment that is configured to convert DC into AC for the oil well equipment;
the first voltage regulator has an incoming line terminal connected to the photovoltaic array and an outgoing line terminal connected to the DC bus that is configured to stabilize a voltage for photovoltaic power generation at DC 600 V;
the second voltage regulator has an incoming line terminal connected to the energy storage unit and an outgoing line terminal connected to the DC bus; and
the third voltage regulator has an incoming line terminal connected to the wind power generation unit and an outgoing line terminal connected to the DC bus that is configured to convert an AC transmitted from the wind power generation unit into a DC which is output to the DC bus for the oil well equipment.

2: The multi-source microgrid power supply system according to claim 1, further comprising a high-voltage switch having a terminal connected to the high-voltage side of the transformer and a terminal connected to the power grid of the mains supply.

3: The multi-source microgrid power supply system according to claim 1, wherein:
the rectifier comprises a filter device and an energy feedback device;
the filter device has an incoming line terminal connected to the low-voltage side of the transformer and an outgoing line terminal connected to an incoming line terminal of the energy feedback device that is configured to filter out harmonics generated by rectification; and
the energy feedback device has an outgoing line terminal connected to the DC bus that is configured to feed surplus electric energy back to the power grid, when it is detected that a voltage of the DC bus is higher than 700 V, in order to prevent equipment damage caused by an overvoltage.

4: The multi-source microgrid power supply system according to claim 1, wherein the photovoltaic array comprises a 300 Wp polycrystalline solar panel.

5: The multi-source microgrid power supply system according to claim 1, wherein the energy storage unit comprises a lithium iron phosphate battery.

6: The multi-source microgrid power supply system in an oil well area according to claim 1, wherein the first voltage regulator comprises a photovoltaic DC-DC voltage regulator.

7: The multi-source microgrid power supply system according to claim 1, wherein the second voltage regulator comprises an energy storage DC-DC voltage regulator.

8: The multi-source microgrid power supply system according to claim 1, wherein the third voltage regulator comprises a rectifying voltage regulator.

9: The multi-source microgrid power supply system according to claim 1, wherein the wind power generation unit comprises a fan.

10: The multi-source microgrid power supply system according to claim 1, wherein the multi-source microgrid power supply system is situated in an oil well area.
